(19) United States
(12) Patent Application Publication
(10) Pub. No.: US 2011/0067825 A1
(43) Pub. Date: Mar. 24, 2011

(54) Digital Printed Privacy Shade

(76) Inventor: Michael Taylor DeBord, Lothian, MD (US)

(21) Appl. No.: 12/565,784

(22) Filed: Sep. 24, 2009

(51) Int. Cl. A47H 5/02; E06B 9/56; G09F 11/00

(52) U.S. Cl. 160/309; 160/340; 40/1

(57) ABSTRACT

The present invention relates to window or doorway shades or blinds assemblies. These assemblies contain top translucent portions for simultaneously allowing indoor occupants to receive natural outdoor light in a room while maintaining the privacy of a closed shade or blind. In addition, these assemblies may be customized with internal and external images, which may be removable or directly printed on the assemblies.

### FIELD OF THE INVENTION

The field of the invention relates to a window or doorway shade covering assembly that may contain a top translucent portion for simultaneously allowing users to receive outdoor light in a room while maintaining the privacy of a closed shade or covering.

### BACKGROUND OF INVENTION

Maintaining privacy in rooms containing windows or doorways is important. However, a room occupant may also want natural light to enter the room through the doorway or window. Raised shades or open blinds allow natural light to enter a room, but only permit limited privacy.

In addition, shades or blinds are not customizable with entertaining, informational or advertising images.

Accordingly, a need exists for a customizable blind or shade system that can allow natural light to enter a room through a window or doorway while protecting the privacy of the room occupants.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

One embodiment of the subject invention is a decorative covering assembly for an opening to a structure comprising: a covering; a retaining means for attaching a top portion of the covering to the structure above the opening; a retraction assembly operatively attached to the covering for raising and lowering the covering, wherein the covering is in a substantially flat position when lowered to cover a user-selected portion of the opening, further wherein the covering comprises a top translucent portion and a non-translucent portion below the top translucent portion, wherein the lowered covering comprises a first flat side which faces into the structure and a second flat side which opposes the first flat side; a first image imprinted on the first flat side of the covering on the non-translucent portion; and a second image on the second flat side of the covering on the non-translucent portion.

In another embodiment of the subject invention, the opening is a doorway or a window.

In an additional embodiment of the subject invention, the retraction assembly includes a drawstring assembly for retracting and lowering the covering.

In a further embodiment of the subject invention, the non-translucent portion of the covering is constructed of a material selected from the group consisting of: a metal, a fabric material, a vinyl polymer, a plastic material, and wood.

In another embodiment of the subject invention, the covering may be rolled down over the opening such that only the non-translucent portion covers the opening.

In an additional embodiment of the subject invention, the translucent portion of the covering is constructed of a translucent plastic, a vinyl polymer or a combination thereof.

In embodiments of the subject invention, the images may comprise cartoon images, photographic images, game images, lithographic images, logos, advertisements, drawings, hand-painted images, and holographic images.

In one embodiment of the subject invention the first image may be an entertaining, informational or an advertisement. In another embodiment of the subject invention, the second image may be entertaining, informational, or an advertisement.

Another embodiment of the subject invention is decorative covering assembly for an opening to a structure comprising: a covering; a retaining means for attaching a top portion of the covering to the structure above the opening; a retraction assembly operatively attached to the covering for raising and lowering the covering, wherein the covering is in a substantially flat position when lowered to cover a user-selected portion of the opening; a first translucent pocket attached to the covering with at least one pocket opening; an imprint inserted into the first translucent pocket through the pocket opening such that the inserted imprint will be substantially flat on covering in the lowered substantially flat position, wherein the unrolled imprint comprises a first flat side which faces the structure and a second flat side which opposes the first flat side, wherein the first flat side of the imprint further comprises a first image.

In another embodiment of the subject invention, a second translucent pocket is attached to the second flat side of the covering, wherein the second translucent pocket contains a second imprint with a second image.

In a further embodiment of the subject invention, the pocket opening is at the top or one side of the first translucent pocket.

In an additional embodiment of the subject invention, the rolled down covering comprises a top translucent portion and a non-translucent portion below the top translucent portion, wherein the first translucent pocket is attached below the translucent top portion of the covering in the substantially flat unrolled position.

In another embodiment of the subject invention, the non-translucent portion of the covering is constructed of a material selected from the group consisting of: a metal, a fabric material, a plastic material, a vinyl polymer, and wood.

In a further embodiment of the subject invention, the translucent portions of the covering and the first translucent pocket are constructed of a translucent material selected from the group consisting of plastic and a vinyl polymer material.

In a further embodiment of the subject invention, the pocket opening is at the top or one of the sides of the covering.

In a further embodiment of the subject invention, the imprint and the first image are both translucent.

In an additional embodiment of the subject invention, the opening is a doorway or a window.

In another embodiment of the subject invention, the retraction assembly includes a drawstring assembly for retracting and lowering the translucent covering.

A further embodiment of the subject invention is a window shade assembly comprising: a roller installed above a window to a room; a shade operatively attached to the roller to allow for the shade to be rolled up into a rolled position and rolled down into a substantially flat position to cover a user-selected portion of the window, wherein the rolled down shade comprises a top translucent portion and a non-translucent portion below the top translucent portion, further wherein the unrolled shade comprises a first flat side which faces into the room and a second flat side which opposes the first flat side; a first image imprinted on the first flat side of the shade on the non-translucent portion; and a second image on the second flat side of the shade on the non-translucent portion.

In another embodiment of the subject invention, the non-translucent portion of the shade is constructed of a material selected from the group consisting of: a metal, a fabric material, a plastic material, a vinyl polymer, and wood.

In one embodiment of the subject invention, the shade may be rolled down over the window such that only the non-translucent portion covers the window.

In a further embodiment of the subject invention, the translucent portion of the shade is constructed of a translucent material selected from the group consisting of plastic and a vinyl polymer material.

An additional embodiment of the subject invention is a window shade assembly comprising: a roller installed above a window to a room; a shade operatively attached to the roller to allow for the shade to be rolled up into a rolled position and rolled down into a substantially flat position to cover a user-selected portion of the window; a first translucent pocket attached to the shade with at least one opening an imprint inserted into the first translucent pocket through the opening such that the inserted imprint will be substantially flat on the shade in the rolled down substantially flat position, wherein the unrolled imprint comprises a first flat side which faces into the room, wherein the first flat side of the imprint further comprises a first image.

In another embodiment of the subject invention, a second translucent pocket is attached to the side of the shade opposing the attached first translucent pocket, wherein the second translucent pocket contains a second imprint with a second image.

In a further embodiment of the subject invention, the opening is at the top or one side of the first translucent pocket.

In an additional embodiment of the subject invention, the rolled down shade comprises a top translucent portion and a non-translucent portion below the top translucent portion, wherein the first translucent pocket is attached below the translucent top portion of the shade in the substantially flat unrolled position.

In another embodiment of the subject invention, the non-translucent portion of the shade is constructed of a material selected from the group consisting of: a metal, a fabric material, a plastic material, a vinyl polymer, and wood.

In a further embodiment of the subject invention, the translucent portions of the shade and the first translucent pockets are constructed of a translucent material selected from the group consisting of plastic and a vinyl polymer material.

In another embodiment of the subject invention, the imprint is non-translucent.

In a further embodiment of the subject invention, the imprint and the first image are both translucent.

In other embodiments of the subject invention, the decorative coverings, shades or blind assemblies may further comprise a magnetic fastener assemblies or hook and loop fastener (such as Velcro®) assemblies. These assemblies may attach and hold the bottom of the unrolled coverings or unrolled shades up against a higher portion of the unrolled covering or unrolled shade, respectively. In an another embodiment of the subject invention, these assemblies may hold the bottom of the unrolled coverings or unrolled shades up against the window sill when pulled and unrolled down beyond the bottom of the window.

One embodiment of the subject invention is a blind assembly for an opening to a structure comprising: a plurality of separately movable slats, the slats being selectively controllable and alignable to substantially cover the opening; a retaining means for attaching a top portion of the slat to the structure above the opening; a retraction assembly operatively attached to the slats for raising and lowering the plurality of slats; stiffening means for maintaining said plurality of slats in a substantially flat configuration in a lowered position, wherein the plurality of slats further comprise a top translucent portion and a non-translucent portion below the top translucent portion, wherein the lowered plurality of slats comprises a first flat side which faces into the structure and a second flat side which opposes the first flat side; a first image imprinted on the first flat side of the plurality of slats on the non-translucent portion; and a second image on the second flat side of the plurality of slats on the non-translucent portion.

In another embodiment of the subject invention, the opening is a doorway or a window.

In an additional embodiment of the subject invention, the retraction assembly includes a drawstring assembly for retracting and lowering the plurality of slats.

In another embodiment of the subject invention, the non-translucent portion of the plurality of slats is constructed of a material selected from the group consisting of: a metal, a fabric material, a plastic material, and wood.

In a further embodiment of the subject invention, the plurality of slats may be rolled down over the opening such that only the non-translucent portion covers the opening.

In one embodiment of the subject invention, the translucent portion of the plurality of slats is selected from a material consisting of plastic, a vinyl polymer or a combination thereof.

In another embodiment of the subject invention, the plurality of slats includes one or more vertical slats.

In an additional embodiment of the subject invention, the plurality of slats includes one or more horizontal slats.

In a further embodiment of the subject invention, the blind assembly further comprises an angle adjustment assembly for varying the angular orientation of one or more of the plurality of slats.

There have thus been broadly outlined important features of the invention in order that the detailed description thereof that follows may be better understood, and in order that the present contribution to the art may be better appreciated. There are additional features of the invention that will be described hereinafter and which will form the subject matter of the claims appended hereto. These together with other embodiments of the invention, and with various features of novelty which characterize the invention, are pointed out with particularity in the claims annexed to and formed as part of this disclosure.

For a conceptual understanding of the invention and its operational advantages, refer to the accompanying drawings and descriptive matter in which there are preferred embodiments of the invention illustrated. Other features and advantages of the present invention will become apparent from the following description of the preferred embodiment(s), taken in conjunction with the accompanying drawings, which by way of example; illustrate the principles of the invention.

### BRIEF DESCRIPTION OF THE DRAWINGS

Advantages of the present invention will be apparent from the following detailed description of exemplary embodiments thereof, which description should be considered in conjunction with the accompanying drawings:

FIG. 1 illustrates a front view of the interior of a window with the privacy shade rolled up into the roller.

FIG. 2 illustrates a front view of the interior of a window with the privacy shade pulled partially down over the window.

FIG. 3 illustrates a front view of the interior of a window with privacy shade pulled to cover the entire window.

FIG. 4 illustrates a front view of the interior of a window with the privacy shade pulled completely down across the window to reveal a top translucent portion.

FIG. 5 illustrates a front view of the exterior of a window with the privacy shade pulled to cover the entire window.

FIG. 6 illustrates a front view of the exterior of a window with the privacy shade pulled completely down across the window to reveal a top translucent portion.

FIG. 7 illustrates a front view of the interior of a window with the privacy shade pulled to cover the entire window with an attached translucent pocket attached containing an image.

FIG. 8 illustrates a front view of the interior of a window with the privacy shade pulled to cover the entire window with an imprint being inserted into the opening of the attached translucent pocket.

FIG. 9 illustrates a front view of the interior of a window with the privacy shade pulled to cover the entire window with an image of a game.

### DETAILED DESCRIPTION OF EMBODIMENTS

The following will describe, in detail, several embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

The subject invention is feature for shades covering windows or doorways. As the blinds or shades are rolled down over the window or doorway, a top translucent portion of the shades is exposed to allow natural light to enter the room. The non-translucent bottom portion of the shades still covers the window or doorway to maintain privacy for occupants inside.

The shades may be adjusted to completely cover the window or doorway, or allow light to enter through the top or bottom. It is only when the bottom of the blinds or shades is pulled down beyond the bottom of the window that the translucent material is revealed at the top.

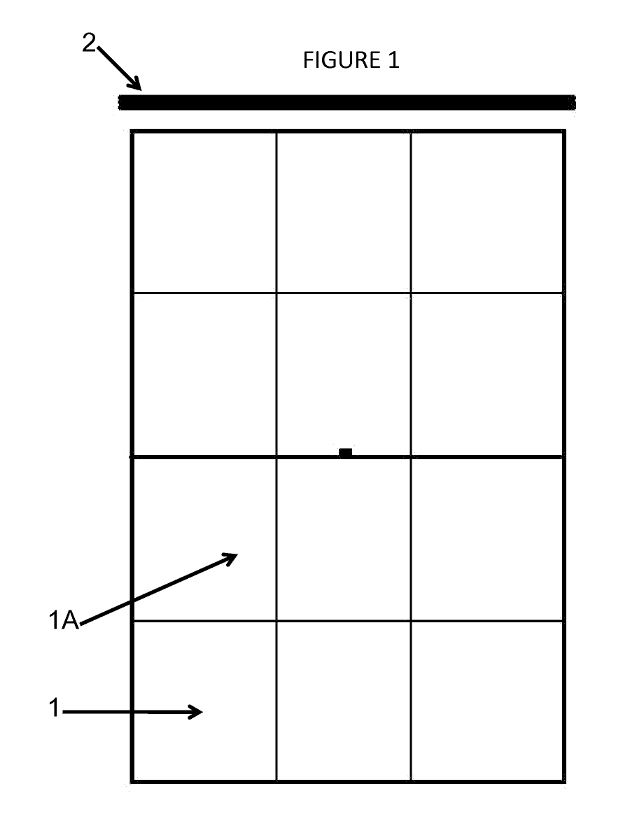

FIGS. 1-4 illustrate a front view of the interior face 1A of a window 1 with the privacy shade 3 and the roller 2. In FIG. 1, the privacy shade 3 is rolled up and contained within a standard roller 2.

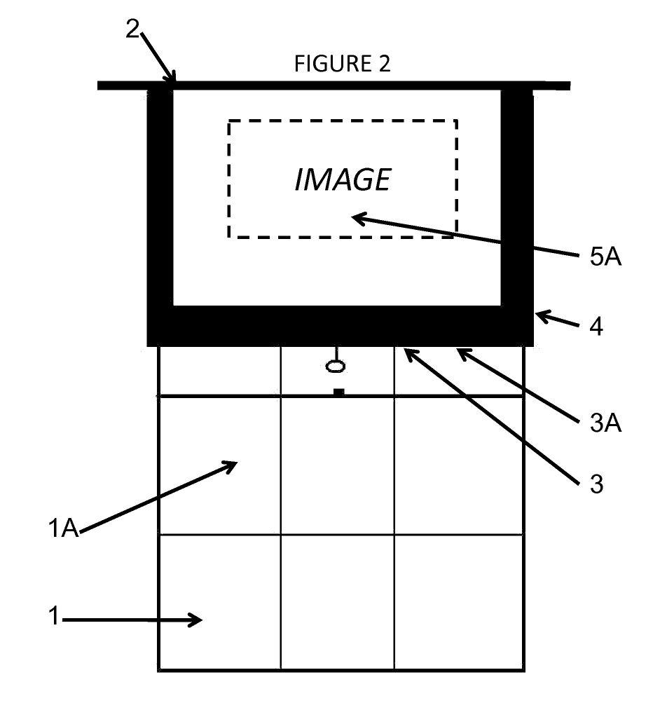

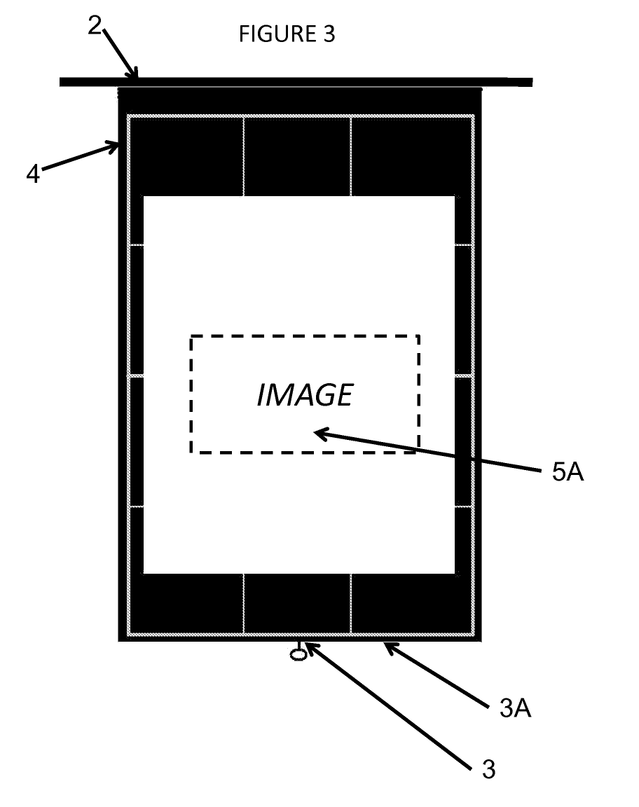

FIGS. 2-4 further illustrate the privacy shade 3 pulled down from roller 2 over window 1 to reveal the non-translucent portion 4 of the privacy shade 3 and interior face 3A of the privacy shade 3. A customized image 5A can be printed onto interior face 3A. As shown in FIG. 2, the privacy shade 3 may only be partially pulled down over window 1. As shown in FIG. 3, the privacy shade 3 may be completely pulled down over window 1 to prevent any natural light from entering the room.

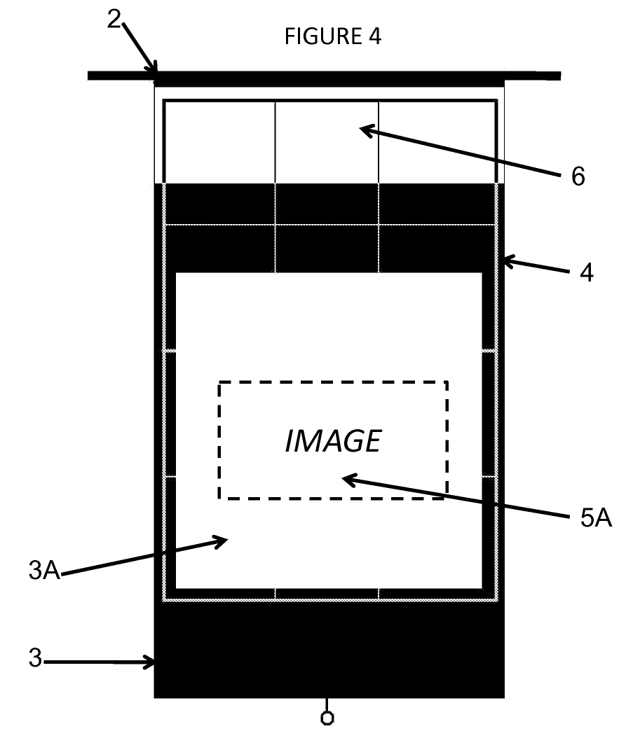

FIG. 4 illustrates the privacy shade 3 being completely pulled down from roller 2. The top of the privacy shade 3 is a translucent portion 6 that allows natural light to enter through the window, while maintaining the privacy with the remaining non-translucent portion of the privacy shade 3.

In one embodiment of the subject invention, the shades may contain an external translucent pocket (not shown) on the internal side of the shades facing the room and a second external translucent pocket facing the window. These external pockets contain at least one opening, on the top or side, for inserting a non-translucent imprint into the translucent pocket. These inserted imprints will be substantially flat within the translucent pockets when the shades are lowered over the window. The imprint may contain images on each side. This imprint will allow users to place their own printed posters or images onto the shade and avoids printing onto the shade altogether.

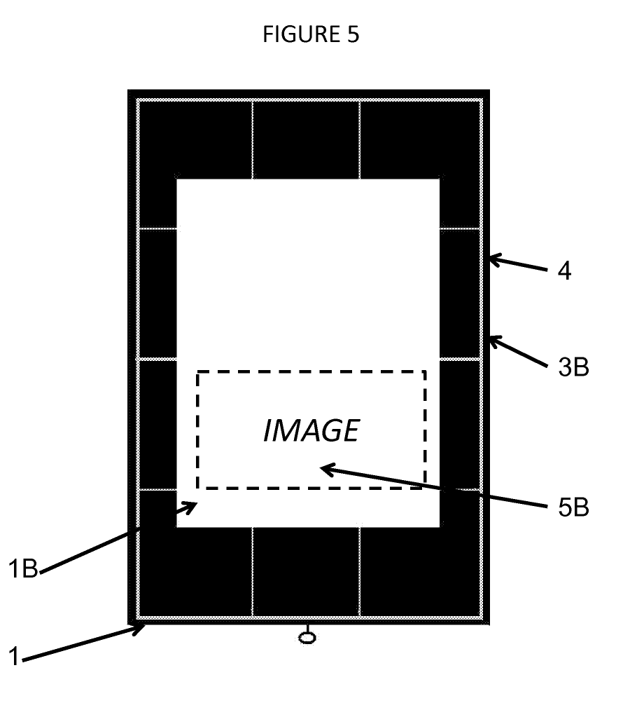

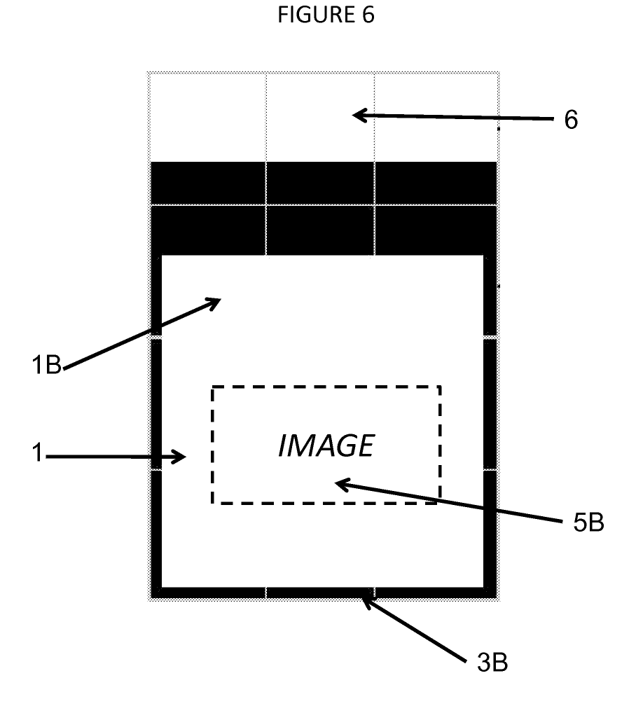

FIGS. 5 and 6 illustrate a front view of the exterior face 1B of window 1 with the privacy shade 3 pulled down to reveal the non-translucent portion 4 and the exterior face 3B of the privacy shade 3. A customized image 5B can be printed onto exterior face 3B. As shown in FIG. 5, the privacy shade 3 may be completely pulled down over window 1 to prevent any natural light from entering the room. FIG. 6 illustrates the privacy shade 3 being completely pulled down from roller 2. The top of the privacy shade 3 is a translucent portion 6 that allows natural light to enter through the window, while maintaining the privacy with the remaining non-translucent portion of the privacy shade 3.

The subject invention may be used in connection with different types of blinds or shades, including, but not limited to: roller blinds, roller shades, cellular blinds, cellular shades, pleated blinds, pleated shades, roman blinds, roman shades, solar blinds, solar shades, woven blinds, woven shades, vertical blinds, vertical shades, horizontal blinds and horizontal shades. The blinds or shades of the invention may be constructed of metals, fabrics, plastics or different types of wood.

Images 5A and 5B may comprise cartoon images, photographic images, lithographic image, logos, advertisements, game images, drawings, hand-painted images, and holographic images. In one embodiment of the subject invention the internal image 5A may be an entertaining or an informational image. In another embodiment of the subject invention, the external image 5B may be an entertaining, informational, or an advertisement image.

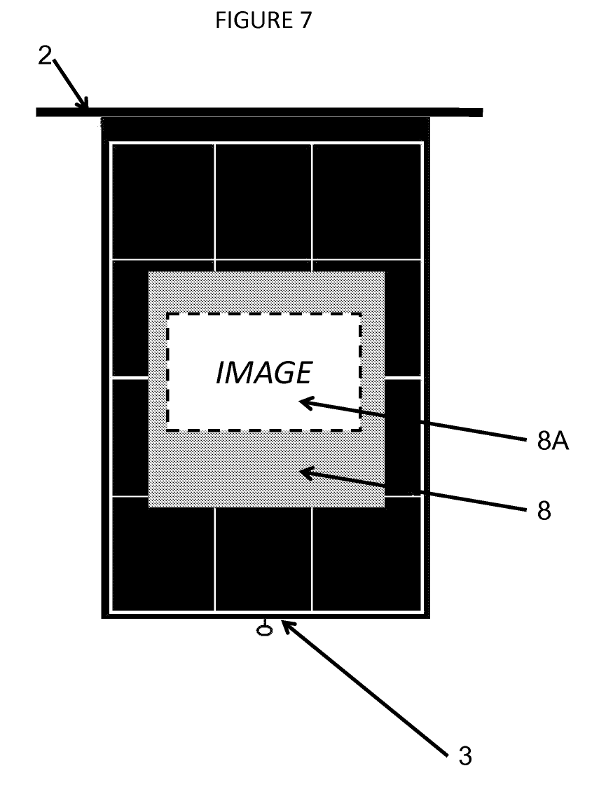

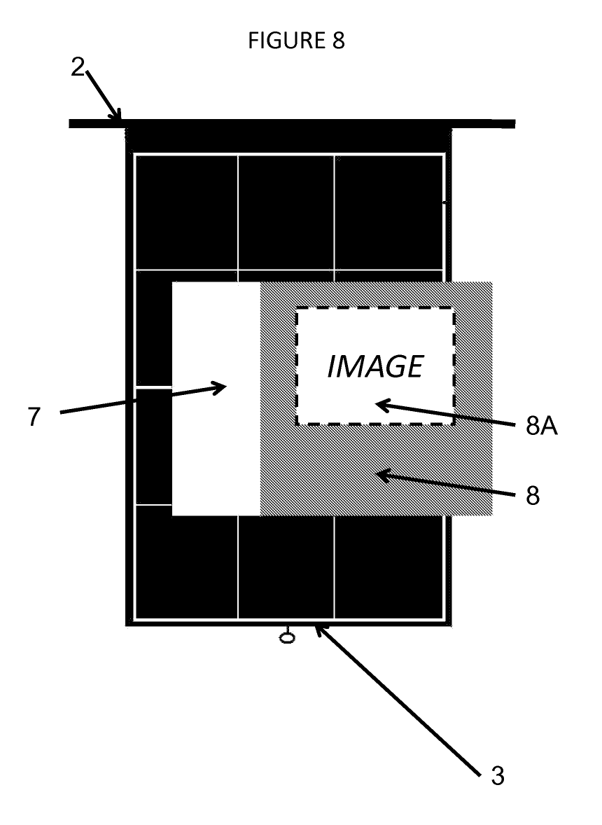

FIGS. 7 and 8 further illustrate the privacy shade 3 pulled down from roller 2 over window 1 to reveal the translucent pocket 7. An imprint 8 with a customized image 8A can be inserted into a pocket opening (not shown) into the translucent pocket. Pocket 7 may have a pocket opening at the top or, as shown in FIG. 8, on the side to allow a user to insert imprint 8 into pocket 7.

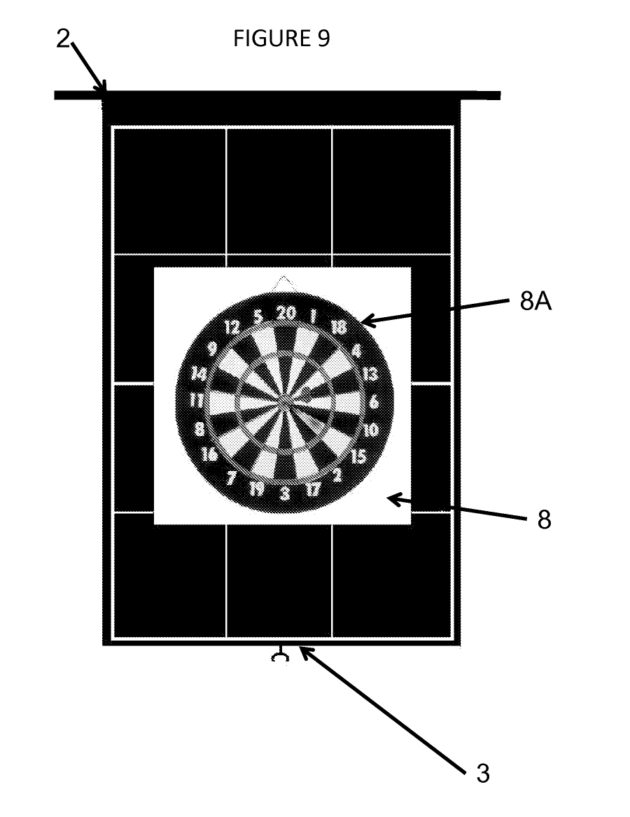

Images 8A on imprint 8 may comprise cartoon images, photographic images, lithographic image, logos, advertisements, game images, drawings, hand-painted images, and holographic images. FIG. 9 illustrates one embodiment of the invention in which customized image 8A is a game image.

The blinds and shades of the subject invention may be attached to a structure through standard retaining means such as a roller. In addition, retraction assemblies may be used to raise and lower the blinds or shades over the window. The retraction assembly may include a drawstring assembly for retracting and lowering the blinds or shades.

The many aspects and benefits of the invention are apparent from the detailed description, and thus, it is intended for the following claims to cover such aspects and benefits of the invention, which fall within the scope, and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A decorative covering assembly for an opening to a structure comprising:
a covering;
a retaining means for attaching a top portion of the covering to the structure above the opening;
a retraction assembly operatively attached to the covering for raising and lowering the covering, wherein the covering is in a substantially flat position when lowered to cover a user-selected portion of the opening, further wherein the covering comprises a top translucent portion and a non-translucent portion below the top translucent portion, wherein the lowered covering comprises a first flat side which faces into the structure and a second flat side which opposes the first flat side;
a first image imprinted on the first flat side of the covering on the non-translucent portion; and
a second image on the second flat side of the covering on the non-translucent portion.

2. The decorative covering assembly of claim 1, wherein the opening is a doorway or a window.

3. The decorative covering assembly of claim 1, wherein the retraction assembly includes a drawstring assembly for retracting and lowering the covering.

4. The decorative covering assembly of claim 1, wherein the non-translucent portion of the covering is constructed of a material selected from the group consisting of: a metal, a fabric material, a plastic material, a vinyl polymer and wood.

5. The decorative covering assembly of claim 1, wherein the covering may be rolled down over the opening such that only the non-translucent portion covers the opening.

6. The decorative covering assembly of claim 1, wherein the first image and second image are selected from the group consisting of: a cartoon image, a photographic image, a lithographic image, a logo, a game image, an advertisement, a drawing, a hand-painted image, and a holographic image.

7. A decorative covering assembly for an opening to a structure comprising:
a covering;
a retaining means for attaching a top portion of the covering to the structure above the opening;
a retraction assembly operatively attached to the covering for raising and lowering the covering, wherein the covering is in a substantially flat position when lowered to cover a user-selected portion of the opening;
a first translucent pocket attached to the covering with at least one pocket opening; and an imprint inserted into the first translucent pocket through the pocket opening such that the inserted imprint will be substantially flat on the covering in the lowered substantially flat position, wherein the unrolled imprint comprises a first flat side which faces the structure and a second flat side which opposes the first flat side, wherein the first flat side of the imprint further comprises a first image.

8. The decorative covering assembly of claim 7, further comprising a second translucent pocket attached to the second flat side of the covering, wherein the second translucent pocket contains a second imprint with a second image.

9. The decorative covering assembly of claim 7, wherein the rolled down covering further comprises a top translucent portion and a non-translucent portion below the top translucent portion, wherein the first translucent pocket is attached below the translucent top portion of the covering in the substantially flat unrolled position.

10. The decorative covering assembly of claim 7, wherein the non-translucent portion of the covering is constructed of a material selected from the group consisting of: a metal, a fabric material, a plastic material, a vinyl polymer, and wood.

11. The decorative covering assembly of claim 7, wherein the translucent portion of the covering is constructed of a translucent material selected from the group consisting of plastic and a vinyl polymer material.

12. The decorative covering assembly of claim 7, wherein the pocket opening at top or side of the translucent first pocket.

13. The decorative covering assembly of claim 7, wherein the opening is a doorway or a window.

14. The decorative covering assembly of claim 7, wherein the retraction assembly includes a drawstring assembly for retracting and lowering the covering.

15. The decorative covering assembly of claim 7, wherein the first image is selected from the group consisting of: a cartoon image, a photographic image, a lithographic image, a logo, an advertisement, a game image, a drawing, a hand-painted image, and a holographic image.

16. The decorative covering assembly of claim 8, wherein the second image is selected from the group consisting of: a cartoon image, a photographic image, a lithographic image, a logo, an advertisement, a game image, a drawing, a hand-painted image, and a holographic image.
